(19) United States
(12) Patent Application Publication
(10) Pub. No.: US 2015/0079497 A1
(43) Pub. Date: Mar. 19, 2015

(54) FUEL CELL DEVICE WITH ELECTROLYTES FLOWING BY MEANS OF PERCOLATION THROUGH ELECTRODES HAVING A POROUS, THREE-DIMENSIONAL STRUCTURE

(71) Applicants: UNIVERSITE DE RENNES 1, RENNES Cedex (FR); CNRS-CENTRE NATIONAL DE LA RECHERCHE SCIENTIFIQUE, PARIS, Cedex 16 (FR)

(72) Inventors: Olivier Lavastre, Gahard (FR); Didier Floner, Servon Sur Vilaine (FR); Dominique Paris, Vern Sur Seiche (FR); Philippe Le Grel, Cesson-Sevigne (FR); Florence Geneste, Servon Sur Vilaine (FR)

(21) Appl. No.: 14/391,895

(22) PCT Filed: Apr. 10, 2013
(86) PCT No.: PCT/EP2013/057470

§ 371 Date: Oct. 10, 2014

(30) Foreign Application Priority Data
Apr. 10, 2012 (FR) 1253269
May 9, 2012 (FR) 1254216

(51) Int. Cl. H01M 8/18; H01M 8/22; H01M 8/20

(52) U.S. Cl. CPC H01M 8/188; H01M 8/20; H01M 8/22
USPC 429/513; 429/105

(57) ABSTRACT

The present invention relates to a fuel cell device with electrolytes flowing by means of percolation through electrodes (1) and (2) having a porous, three-dimensional structure. The invention also relates to the various uses of said fuel cell device in the transport field and station ship field.

### 1. FIELD OF THE INVENTION

The present invention pertains to a particular fuel cell device with circulating electrolytes and to its various applications in the sector of transportation and the sector of stationary equipment.

### 2. PRIOR ART

The rise in worldwide demand for energy and the imperatives of limiting greenhouse gases related to human activity have made it necessary to develop more efficient, cleaner and electrical and industrially viable electrical generators which, if necessary, can act as an adjunct to other sources called clean energy sources (solar energy, wind power, etc) but have problems of intermittence (i.e. absence or presence of wind, sunlight, etc). This need is particularly great in the transportation sector (automobiles for example) and the stationary equipment sector (dwellings for example), which are the main contributors to greenhouse gases.

One of the main lines of research being developed to meet this need relates to the development of improved electrochemical generators.

Electrochemical generators are usually listed under three classes: electrical power cells, accumulators and fuel cells. All these generators have the property of converting the chemical energy provided by a redox or oxidation/reduction reaction into electrical energy.

In general, an electrochemical generator comprises two electrodes bathing in a solution of electrolytes a separator that can take the form of an electrochemical bridge or a membrane permeable to the ions of the electrolyte support. At the terminals of each of these electrodes, there is an oxidation reaction and a reduction reaction respectively, bringing into play one of the reagents of the oxidation/reduction or redox reaction which causes the generator to work.

The term “anode” refers to the electrode in which there takes place the oxidation reaction that will release electrons. The anode corresponds to the negative terminal of the generator. The term “cathode” refers to the electrode in which the reduction reaction takes place. The cathode corresponds to the positive terminal of the generator.

The current delivered is proportional to the concentration of the species brought into contact with the electrodes.

Electrical power cells, also called cells or primary generators, work as a closed system and discharge their electrical energy without having the possibility of returning to their initial state. In other words, once the electroactive species of the oxidation/reduction reaction are depleted, the cell cannot be recharged and must be replaced.

Accumulators or secondary generators are also closed systems but, by contrast, are reversible, i.e. they can be electrically recharged after being discharged if they are provided with electrical energy from outside, for example through another generator. Accumulators are designed to support many charging/discharging cycles. In the discharging mode, an accumulator works as an electrical power cell, and in charging mode it works as an electrolyzer. In the latter case, the electroactive species of the oxidation/reduction reaction consumed during the depletion of the cell are then regenerated and can be reutilized. However, the energy capacity of the accumulators remains limited by the volume of the system.

Fuel cells have the advantage of being open systems. Their capacity therefore is not limited by such a limitation of volume. Fuel cells can work:
either in cell mode by a permanent contribution of electroactive species necessary for the oxidation/reduction reactions at the electrodes with a reducing agent as fuel at the anode, and an oxidizing agent as a combustive agent in the cathode;
or in battery mode by the regeneration of the electroactive species by action of an electrical current.

In addition, they are differentiated from the classic accumulators and electrical power cells by the nature of the electrodes which undergo no modification of structure during electrochemical reactions but serve only as a support for these reactions, and which can replace a specific catalytic activity relative to the fuel and the combustive agent, for example with the use of platinum.

At present, six types of fuel cells can be distinguished. They differ by the nature of the fuel: hydrogen, methanol, natural gas; the nature of the electrolyte (solid or fluid); the nature of the ions transported: H⁺ or carbonates; the working temperature; and the nature of the application.

In the context of the present invention, more particular focus is placed on fuel cells with circulating electrolyte solutions.

The terms “electrolyte solution’” designates a solution comprising at least one electrolyte as a solute. Electrolytes are ions (Na⁺, sulphate, H⁺, OH⁻, etc) that favor the passage of current within the electrolyte solution. In particular, the term “electrolytes” is applied to the ions that actively participate in the transportation of current. An electrolyte solution is therefore electrically conductive. The electrolytes can be obtained for example by dissolving a salt corresponding to a combination of cations and anions in the solvent of the electrolyte solution. Electrolyte solutions can furthermore include an oxidizing agent and a reducing agent.

The term “anolyte” refers to the electrolyte solution additionally containing at least one electroactive species playing the role of a reducing agent. The term “catholyte” defines the electrolyte solution that additionally contains at least one electroactive species acting as an oxidizing agent.

The electroactive species needed for the electrodes are stored in storage compartments (tanks) situated outside the electrochemical reactor, which is the seat of the oxidation-reduction reactions. In this way, the capacity of the fuel cell no longer depends on its own volume but on the volume of the storage compartments while the power of the fuel cell is still related to the size of the reactor. The decoupling of these two parameters is an advantage for the massive storage of energy in networks. To achieve this result, it is important to have available sufficiently sized tanks while independence with regard to power is conditioned by the use envisaged.

The size of the tanks can thus be adapted to the energy requirements of the applications developed such as systems needing small quantities of energy (portable devices), medium quantities of energy (vehicles) or very high quantities of energy (residences and other buildings).

The power of the fuel cell for its part can be modulated according to the size of the electrochemical reactor. Indeed, this reactor can be constituted by one or more unit cells that are parallel-connected or series-connected so as to obtain the intensity of the current or the electromotive force desired. Each unit cell comprises at least one anode, one cathode and one electrolyte solution comprising at least one oxidizing agent and/or reducing agent, and is capable of producing electricity from an oxidation/reduction reaction. The power of the fuel cell obtained then depends on the number of unit cells assembled and on their surface area. A wide range of power values from one kilowatt (kW) to several megawatts (MW) can thus be obtained. In addition, there is a large number of redox pairs that can be implicated in each unit cell.

Another advantage of fuel cells with circulating electrolytes lies in the capacity of the system to work continuously. When the electroactive species coming into play in the oxidation and reduction reactions are exhausted in proximity to the electrodes, these species are continuously replaced by the circulating flow of the electrolyte solution. The system is therefore rechargeable without any need to interrupt the production of current.

Fuel cells with circulating electrolytes have numerous advantages as mentioned here above. However, the existing systems do not give full satisfaction in terms of electrical and energy efficiency and remain be improved. In addition, the time taken for recharging after exhaustion of the electroactive species often hampers long-term use (for example use of the order of several days) and impairs the continuous and homogenous production of electricity. Chiefly, the regeneration of at least one of the oxidizing electroactive species or reductive electroactive species requires several passages of the electrolyte solution through the unit cells at the contacts of the electrodes. This obligation leads to excess energy costs resulting from the low Faraday efficiency of the electrolyte and the excessive operation of the pumps.

In addition, the diversity of the redox systems used in the presently existing systems (cells and batteries) with circulating electrolytes is very small and consists chiefly of a few elements of the periodic table of the family of metals (vanadium, zinc and iron) or the family of halogens (bromine and chlorine).

### 3. GOALS OF THE INVENTION

The problem that the present invention seeks to resolve is that of devising an electrochemical generator that overcomes these disadvantages while at the same time preserving the advantages of existing fuel cells with circulating electrolytes.

In particular, the present invention seeks to obtain an electrochemical generator that is capable of generating electrical energy continuously or acting as a support to other intermittent energy sources, and of speedily storing and using electrical energy as required and is therefore speedily rechargeable.

### 4. SUMMARY OF THE INVENTION

This problem has been resolved by the devising of a fuel cell device with electrolytes circulating by percolation through electrodes with a porous three-dimensional structure. The Applicant has discovered that the percolation of electrolyte solutions through electrodes with a porous three-dimensional structure improves the efficiency of the is with circulating electrolytes as compared with existing systems in which the electrolyte solutions simply enter into contact with the surface of the electrodes without passing through them. The heightened efficiency of these unit cells can be explained especially by the higher surface area of contact between the solution and the porous electrode for electrodes of a same volume.

The invention therefore pertains to a fuel cell device with circulating electrolytes that is rechargeable as defined here above.

In particular, the device according to the invention is rechargeable, and capable of generating or cogenerating, storing and using electrical energy.

The device according to the invention has one or more of the following advantages:

It can be put into operation and recharged speedily, for example within a few minutes or even a few seconds as compared with classic accumulators for a same electrode volume.

The time of starting up the device is calculated according to the relationship t=V/d, where:

t represents the optimizing time for the electromotive force and for the intensity of the current of the fuel cell with circulating electrolytes (min); it represents the duration needed to shift a volume V,

V represents the volume of each electrode (dm³) and

d represents the flow rate of the electrolyte solutions (dm³/min).

The time for recharging the device is computed according to the solution t_{R}=V_{R}/d, where:

t_{R} represents the recharging time (min),

V_{R} represents the volume of the tank (dm³) and

d represents the flow rate of the electrolyte solutions (dm³/min).

The rate of recharging the device according to the invention preferably varies from 95% to 100% in a single passage of the electrolyte solution (anolyte, catholyte) throughout the circuit of the device and more specifically a single passage of the entire volume of the electrolyte solution through the electrode.

In addition, the device according to the invention has high electrical efficiency that is independent of the size of the electrochemical reactor.

It has high properties of energy storage and increased autonomy adapted to long durations of use, independently of the size of the electrochemical reactor. This is achieved through the tanks of electrolyte solutions.

Besides, the electrodes of the device according to the invention, through which the electrolyte solutions percolate, possess increased mechanical properties as compared with classic electrodes and do not enable the electrolyte solutions to percolate through them.

Other objects, aspects and characteristics of the present invention shall appear clearly from the description of the examples.

An object of the invention is also a fuel cell device with circulating electrolytes comprising:
at least one unit cell having a positive compartment provided with an anode and a negative compartment provided with a cathode, said compartments being separated by an ion-permeable membrane;
at least one tank of an electrolyte solution containing at least one oxidizing agent as an electroactive species, called a catholyte, provided with a first conduit for conveying catholyte into said positive compartment and a second conduit for discharging catholyte from said positive compartment;
at least one first pump enabling the circulation of the catholyte in a circuit comprising the tank of catholyte, the first conduit for conveying catholyte into the positive compartment, the positive compartment and the second conduit for discharging said catholyte;
at least one tank of electrolyte solution containing at least one reducing agent as an electroactive species, called an anolyte, provided with a first conduit for conveying said anolyte into said negative compartment and one second conduit for discharging said anolyte from said negative compartment;
at least one second pump enabling the circulation of anolyte in a circuit comprising the anolyte tank, the first conduit for conveying anolyte into the negative compartment, the negative compartment and the second conduit for discharging anolyte;
the cathode and the anode having a porous three-dimensional structure;
the positive compartment comprising a positive downstream compartment and a positive upstream compartment separated by the anode, the first conduit for conveying catholyte being connected to the positive upstream compartment and the second conduit for discharging catholyte being connected to said positive upstream compartment,
the negative compartment comprising a negative downstream compartment and a negative upstream compartment separated by said cathode, the first conduit for conveying anolyte being connected to said negative upstream compartment and the second conduit for discharging anolyte being connected to said negative downstream compartment,
said catholyte and anolyte being capable of travelling in transit by percolation respectively through said anode and said cathode;
the solutions of catholyte and anolyte passing through said anode and said cathode in a flow orthogonal to the longitudinal axis of said anode and said cathode.

Because of such characteristics, the electrolyte solution (catholyte, anolyte) must percolate through the electrode (anode, cathode) in order to pass from the downstream compartment to the upstream compartment. This is possible especially because of the porous three-dimensional structure of the electrode. The characteristic according to which the solutions of catholyte and anolyte pass through the electrodes in a flow orthogonal to the longitudinal axis of these electrodes prevents excessive pressure, during said percolation, within the three-dimensional porous materials constituting these electrodes. The longitudinal axis of the electrodes is the one passing through their greatest dimension (length or height or diameter). In practice, these electrodes are flat in shape and have a small thickness. In particular, they could be parallelepiped-shaped.

The cathode and/or the anode used in the device according to the invention can be made out of a material chosen from the group constituted by foams, felts, fabrics and overlaying of fabrics. Preferably, felt will be used. The cathode and/or anode used in the device according to the invention is thus preferably made out of carbon-fiber felt and more preferably graphite-fiber felt. Graphite is preferred because it has electrical conductivity greater than that of carbon.

Graphite-fiber felts that can be used include the ones commercially available through the companies Mersen or Pica. There are two thicknesses available: 12 mm commercially distributed by the firm Mersen under the reference RVG-4000 and 6 mm corresponding to RVG-2000. Apart from the thickness, these materials are exactly identical. These felts are constituted by an interlacing of graphite fibers. The very high porosity of felt is hard to quantify and the values used correspond rather to the spaces between the fibers, which have varying sizes, rather than to pores with well-defined diameters.

The apparent surface area evaluated by the firm Mersen (using the method known as the B.E.T. method) is 0.7 m²·g⁻¹. The overall appearance of each fiber, the mean diameter of which ranges from 20 to 25 microns, is apparently very homogenous. These fibers, manufactured by Mersen itself, are obtained by pyrolysis of an acrylic-based polymer.

The felts proposed by the firm Pica are also commercially distributed in rolls but with a maximum thickness of 0.3 cm. One of the felts marketed by Pica is characterized by a very great specific surface area of 1200 m²·g⁻¹, measured according to Pica by the B.E.T. method, corresponding to a surface area about 1700 times greater than that of the Mersen graphite felts. This is explained by the fact that the mean diameter of the fibers is small, about 10 microns, and that the fiber density is high.

When the cathode and/or anode are made of graphite-fiber felt, they can be used as such or modified by one or more of the following methods of preparation:
a) covalent fixing of one or more catalysts on at least one of the surfaces of the cathode or the anode,
b) total metalizing of the graphite fibers of the cathode and/or anode, thus giving a homogenous deposit throughout the surface of the fibers, without any trace of graphite remaining bared, both on the periphery and inside the felt,
c) coating with a polymer film on at least one of the surfaces of the cathode or anode.

As a catalyst that can be used, it is possible to choose for example a cyclic organic complex comprising at least one primary or secondary amine function such as a metal complex of phthalocyanine, possibly substituted, or porphyrine, possibly substituted, such as an iron, cobalt, copper, nickel or noble metal complex or again phenazathionium (or methylene blue) or a substituted phenazathionium.

By way of a polymer that can be used for the method of preparation c) defined here above, it is possible to choose for example a polymer from the family of polypyrroles, the family of polythiophenes, the family of polyanilines, the family of ethylenedioxythiophenes (EDOT). Preferably, a polymer of the family of polypyrroles or polythiophenes will be used.

Preferably, when the cathode and/or the anode are made of graphite fiber felt, they can be used as such or metalized.

Furthermore, they can, in one variant, be coated with a polymer.

According to one variant, a catalyst can also be fixed by covalent bonding to the surface or said cathode and/or said anode.

The method of fixation by covalent bonding of one or more catalysts can be done directly on at least one of the surfaces of the graphite-fiber felt of the cathode or anode or directly on the polymer film fixed to the possibly metalized graphite fibers.

In the case of an aniline type catalyst with an amine function, the method of fixation by covalent bonding can be performed for example by electrochemical reduction of a diazonium salt. The method consists in generating in solution a diazonium salt from the corresponding amine of the catalyst. The diazonium salt is then subjected to electrochemical reduction on electrode. The reduction leads to the formation of a radical carbon which gets fixed (bonded) covalently to the surface of the electrode. This reaction is accompanied by a release of N₂.

Another method is to incorporate one or more catalysts into the structure of a polymer thus making it electroactive. The fixing of one or more catalysts as defined here above can be done on at least one of the graphite-fiber felt surfaces preliminarily coated with an electroactive polymer film of the cathode or the anode. The coating of the electroactive film around the graphite fibers is done by “electro polymerization” of a monomer. There are numerous monomers such as: aniline, pyrrole, thiophene, etc. Electropolymerisation is an electrochemical technique which enables the generation, in oxidation, of the radicals that are derived from monomers and will get bonded to each other to form a conjugate polymer. By preliminarily fixing one or more catalysts to one or more monomers, the catalyst or catalysts are blocked on the surface of the electrode through the formation of the polymer. Electropolymerisation thus coats the surface of the graphite-fiber felt electrode with a polymer film incorporating one or more catalysts.

The cathode and the anode can be made out of identical or different materials.

It is thus possible, in the device according to the invention, to use for example a cathode and/or anode made out of graphite-fiber felt, entirely metalized graphite-fiber felt possibly coated on at least one of its surfaces with a polymer film to which there is or are covalently fixed, if necessary, one or more catalysts, made of graphite-fiber felt coated on at least one of the surfaces with a polymer film to which one or more catalysts are fixed as the case may be covalently, or into which there are incorporated one or more catalysts.

Preferably, electrodes made of metalized graphite-fiber felt are used.

The electrodes used according to the invention are not limited as regards their shape or their thickness. Preferably, they have a thickness greater than 0.3 cm. More preferably, they have a thickness of up to 1.2 cm.

Each electrode can be positioned parallel to the plane of the ion-permeable membrane or perpendicularly to it. Advantageously, all the electrodes are positioned parallel to the plane of the ion-permeable membrane. This configuration gives a compact unit cell and therefore a device that takes up little space.

The electrodes used in the device according to the invention have both a large specific surface and high microporosity. This is an advantage for the miniaturization of the electrochemical generators.

The graphite fibers can be obtained by pyrolysis of an acrylic type basic polymer.

The metallization of the graphite fibers of the cathode and/or of the anode can be done by electrodeposition by a method such as the one described in the patent application FR2846012.

One of the techniques for coating metalized graphite fibers with a usable polymer film is the one described in the patent application FR2914931.

The electrolyte solutions that can be used in the device according to the invention are liquid fluids containing ions called supporting electrolytes, additionally containing at least one oxidizing agent or at least one reducing agent. The term “anolyte” refers to the part of the electrolyte solution containing the reducing agent in contact with the anode of a negative compartment or the negative compartment of the fuel cell device according to the invention. The term “catholyte” refers to the part of the electrolyte solution containing oxidizing agent in contact with the cathode of a positive compartment or the positive compartment of the fuel cell device according to the invention. The anolyte is an electrolyte solution comprising at least one reducing agent. The catholyte is an electrolyte solution comprising at least one oxidizing agent.

The liquid fluid generally used as a solvent of the electrolyte solutions is generally an aqueous (water) solution that can be acid, basic or neutral.

Preferably, the anolyte and the cathode are aqueous solutions of the same nature (acid, basic or neutral). Preferably, the anolyte used is an aqueous electrolyte solution comprising at least one reducing agent. The reducing agent undergoes a spontaneous oxidation reaction in the negative compartment at the anode when the device generates current (operation of the fuel cell).

Among the reducing agents that can be used, we may cite hydrazine, alcohols of low molecular mass such as C₁-C₄ alcohols, such as methanol, ethanol or glycol ethylene, polyalcohols or sugar alcohols from sugars such as glucose or fructose, sulphated derivatives (—SH) such as sulfated amino acids, such as cystine or homocystine, hydrazones, natural reducing agents such as ascorbic acid, gluthalione, flavin adenine dinucleotide (FAD), nicotinamide adenine dinucleotide hydride (NADH) or nicotinamide adenine dinucleotide phosphate (NADPH), organic reducing agents such as catechol and quinone derivatives, organo-metallic reducing agents based for example on cyclam derivatives and systems based on metals such as for example vanadium.

Preferably, the catholyte used is an aqueous electrolyte solution comprising at least one oxidizing agent. The oxidizing agent undergoes a reaction of spontaneous reduction in the positive compartment at the cathode when the device generates current (operation of the fuel cell).

Among the oxidizing agents that can be used, we may cite oxidizing agents of the following pairs: ferricyanide/ferrocyanide, respectively corresponding to a complex salt containing a trivalent ion Fe(CN)₆³⁻ and a complex salt enclosing the tetravalent Fe(CN)₆⁴⁻, the organic oxidizing agents such as derivatives of catechol and quinones, especially hydroquinones, organo-metallic oxidizing agents based for example on cyclam derivatives, metallic complexes of iron (Fe³⁺/Fe²⁺) or of cobalt (Co³⁺/Co²⁺) with one of the phenanthroline ligands, citric acid or ethylenediaminetetraacetic acid (EDTA), and Ce⁴⁺/Ce³⁺; ferrocene and substituted ferrocenes; metal-based systems such as for example vanadium, dioxygen. The preferred oxidizing agent is ferricyanide, especially potassium ferricyanide. Potassium ferricyanide coexists in an aqueous solution with ferrocyanide.

Advantageously, cyclams complexated with transition metals can be used as circulating electrolytes.

1,4,8,11-tetraazacyclotetradecane, known as “cyclam” is part of the family of tetraaza-cycloalkanes. Cyclam, represented here below comprises four nitrogen atoms placed in a symmetrical configuration.

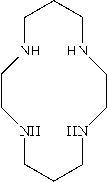 [SMILES: C1CNCCNCCCNCCNC1]

The nitrogen atoms of cyclam, through their free electron doublet and their positioning in space, give cyclam a high complexing capacity as compared with numerous metal cations of different valences: Co³⁺, Co²⁺, Co⁺, Ni³⁺, Ni²⁺, Ni⁺, etc. As a rule, cyclam complexes all the transition elements M and does so with variable degrees of oxidation.

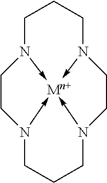

Cyclam complexes possess one or two electrochemical systems according to the nature of the metal cation. For example, cyclam (Ni) possesses two redox systems, one of which is situated at low potential and the other at high potential.

For each pair, the reversible reactions (charging and discharging) brought into play are the following:

Cyclam (Ni³⁺)+e⁻=Cyclam (Ni²⁺) E₁

Cyclam (Ni²⁺)+e⁺=Cyclam (Ni⁺) E₂

In the case of the metal cations of valence 3 (nickel, cobalt, iron, etc), the difference in potential between the redox systems is of major interest since it is greater than 1 V. In other words, these molecules can be used equally well as reducing agents in the anolyte and as oxidizing agents in the catholyte of a circulating electrolyte battery.

The use of cyclams as an electrolyte has an advantage of not causing any problem if a mixture of anolyte and catholyte occurs by cross-over or passage through the membrane of the battery.

The diversity of these molecules and their solubility in the basic media makes them in addition highly important in the use of energy storage systems with circulating electrolyte.

The molar concentration in reducing agent and the molar concentration in oxidizing agent present in the unit cell or each unit cell of the device according to the invention, in anolyte and catholyte, are chosen preferably so as to obtain the desired electromotive force and intensity, and therefore the desired power. The electromotive force of the fuel cell device is defined by the Nernst law.

The current delivered is proportional to the molar concentration in reducing agent in the positive compartment and the molar concentration in oxidizing agent in the negative compartment of each unit cell or of the unit cell of the device.

The device according to the invention can be constituted by one or more parallel-connected or series-connected cells. This assembly can especially give increased electrical power.

The membrane permeable to the ions of the supporting electrolyte used in the device according to the invention separates the anolyte from the catholyte and prevents any contact between the reducing agent contained in the anolyte and the oxidizing agent contained in the catholyte. The membrane is chosen so as to withstand the oxidizing environment of the anode and the reducing environment of the cathode. In addition, the membrane is preferably chosen to favor the passage or cross-over through the membrane of the ions of the supporting electrolyte, and especially that of the protons (Fr) and/or hydroxyls (OFF), present and/or generated in the anolyte and the catholyte, so as to minimize the electrical resistance of the membrane.

Preferably, the membrane used is a membrane permeable to at least one common ion present in the catholyte and the anolyte. In particular, the membrane used is permeable to the protons and to the hydroxyls. In particular, the membrane used is permeable to the protons (H⁺) when the anolyte and the catholyte are acid solutions. The membrane used is permeable to the hydroxyls (OFF), when the anolyte and the catholyte are basic solutions.

The presence of a pump or pumps providing for the circulation of catholyte and anolyte in the device according to the invention facilitates the passage of these fluids through the anode and the cathode respectively. The pump or pumps used are those conventionally used for classic fuel cells. It is possible for example to use peristaltic pumps. The location of the pumps in the device is not critical in as much as they fulfill their function of putting the electrolytes into circulation.

The tank of an anolyte comprises said anolyte. The tank of a catholyte comprises said catholyte. The size of the tanks used in the device according to the invention is chosen preferably as a function of energy requirements of the applications developed and the desired autonomy: systems using small quantities of energy (portable devices), or having average energy requirements (vehicle) or very heavy energy requirements (in residential or other buildings for purposes of heating, air-conditioning or current supplies). They can also depend on the concentration in active species (oxidizing)/reducing agents in each tank.

Advantageously, the device according to the invention comprises at least one system for recycling and/or enriching electrolyte solutions enabling the resupply and/or enrichment of the anolyte and catholyte tanks in active species (reducing agent and oxidizing agent respectively). Each recycling system is placed between the outlet of the electrolyte discharge conduit and the inlet conduit of the electrolyte tank.

The recycling can be obtained by simple reintroduction of the non-reacted active species in the tanks (recirculation of outgoing electrolyte solutions).

The enrichment in active species can be obtained by an electrochemical reaction which is the reverse of the one taking place in the electrochemical cell.

More specifically, the enrichment of the electrolyte solutions (anode and cathode) can be done advantageously by closed-loop electrolysis through the same electrodes (electrochemical cells) of the circulating electrolyte fuel cell device. To this end, an electrical current from an external source is imposed at the terminals of the electrodes of the fuel cell.

The sense of the flow of the electrolytes passing through the electrodes with porous three-dimensional structures is the same as in energy production mode and therefore retains the advantage of a cross-over of electrolyte from the membrane towards the electrodes.

The electrolyte tank can also be enriched for example in 1,2,4,5-tetraol benzene by making the oxidized reducing agents recovered at the outlet of the electrochemical cell undergo a reduction reaction (for example by electrolysis). The catholyte tank can also for its part be enriched for example with potassium ferricyanide in making the reduced oxidizing agents recovered at the outlet of the electrochemical unit cell undergo an oxidizing reaction (for example by electrolysis or oxidation by means of dioxygen).

The concentration in reducing agent in the anolyte tank can also be different from the concentration present in the negative (anode) compartment of the cell. Similarly, the concentration in oxidizing agent in the catholyte tank can be different from the concentration present in the positive compartment (cathode compartment) of the unit cell. In particular, the concentration in reducing agent in the anolyte tank can be greater than or equal to the concentration of reducing agent within the anode compartment. Similarly, the concentration in oxidizing agent in the catholyte tank can be greater than the concentration in oxidizing agent within the cathode compartment.

In one particular embodiment, when the redox pairs used in the tanks of the device according to the invention are reversible, the energy content of these tanks can be regenerated by electrolysis (reversal of the operation of the unit cell), for example by applying electrical energy directly at the electrodes. In this case, the device according to the invention works like a battery with two modes of operation known as “charging” (electrolysis) and “discharging” (fuel cell). In “charging” mode, the oxidation/reduction reactions which take place in the positive and negative compartments of the unit cell or of each unit cell in recharged mode of the device are reversed from those that take place during the operation of the fuel cell. The active species described here above as a reducing agent undergoes a reaction of reduction in the positive compartment at the anode while the active species described here above as an oxidizing agent undergoes an oxidizing reaction in the negative compartment at the cathode. In this case, it is possible preferably to use 1,2,4,5-tetraol benzene as a reducing agent instead of irreversible reducing agents, such as hydrazine, for which the irreversible oxidation reaction leads to the formation of molecular nitrogen.

Preferably, the electrical energy used to obtain an electrolyte of the active species is contributed by means of a freely available external energy source (sun, wind, tides, cascaded waterfalls, deceleration, etc) converted into electrical energy.

Again, according to a preferred variant of the invention, said membrane is juxtaposed with the cathode and the anode, i.e. no compartment is made is made between the membrane and the electrode.

Again, according to a preferred variant of the invention, the circulation of catholyte is implemented in the sense going from the membrane to the anode and the circulation of anolyte is implemented in the sense going from the membrane to the cathode respectively.

Again preferably, the device comprises a plate for distributing the flow of anolyte and a plate for distributing the flow of catholyte.

According to one variant, said catholyte and said anolyte comprise irreversible reducing and oxidizing agents.

According to another variant, said catholyte and said anolyte comprise reversible reducing and oxidizing agents, the device being capable of working in discharge mode and in charging mode by apposition of an electrical current from a source external to the terminals of the anode and the cathode.

The device according to the invention can be used for various applications in the transportation sector (electrical vehicles) and in the sector of stationary equipment (uses in residential and other buildings for heating, air-conditioning and supply of current).

It can also be used as an energy node of an electrical network through a high capacity of energy storage.

### 5. DESCRIPTION OF EMBODIMENTS

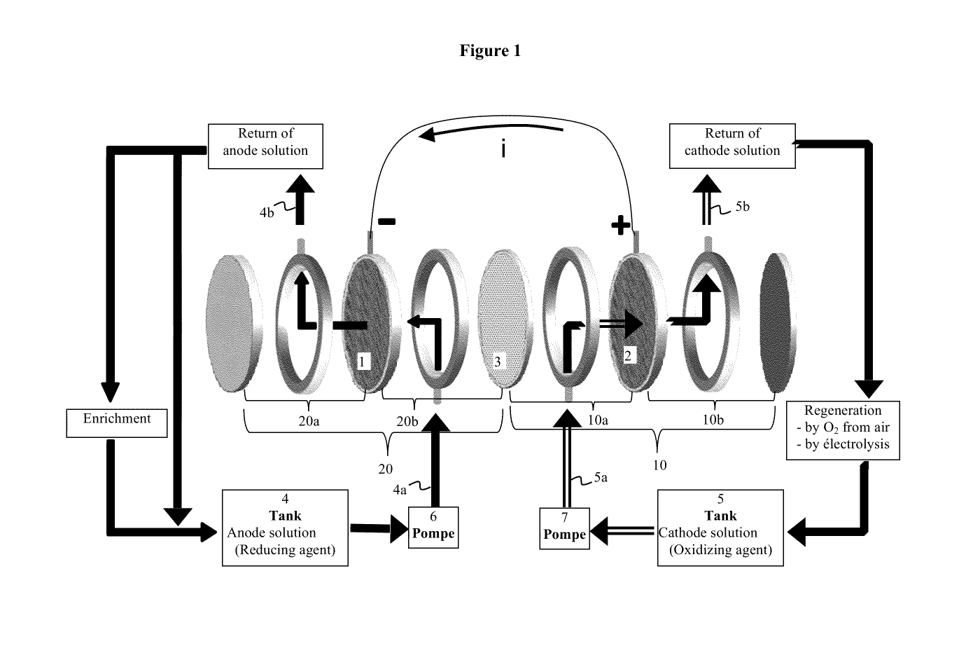

Five embodiments of devices according to the invention have been made. These embodiments are represented schematically in FIGS. 1 to 5.

The first embodiment schematically represented in an exploded view in FIG. 1, comprises the following elements:
a unit cell formed by a positive compartment (10) and a negative compartment (20);
two porous three-dimensional electrodes (1) (2) presenting the shape of disks: made out of graphite-fiber felt (1) and graphite-fiber felt metallized with nickel (2), both having a thickness of 3 mm and a diameter of 8.5 cm;
two pairs (11, 12 and 13, 14) of holding rings (10a, 10b) and (20a, 20b) positioned on either side of each porous electrode (1) and (2) respectively, demarcating positive upstream/downstream compartments (10a, 10b) and negative upstream/downstream compartments (20b, 20a), all identical: 5 mm thickness and 7.5 cm of internal diameter. The difference in internal diameter between the porous electrode and the rings enables the electrode to be held in a simple way during the circulation of the fluid. Each ring (11, 12, 13, 14) is crossed by a tube (11a, 12a, 13a, 14a) having an external diameter of 3 mm. Each ring thus has two openings (external and internal) corresponding to an inlet and outlet of electrolyte solution, or vice versa. The rings (11, 13) placed flat against the membrane (3) are each crossed by a tube (11a; 13a) situated at the bottom of FIG. 1, corresponding to the inlet of electrolyte solution (anolyte or catholyte) into the electrochemical cell. The rings (12, 14) placed flat against the two external supporting plates (15, 16) of the device are crossed by a tube (12a; 14a) situated towards the top in FIG. 1, corresponding to the outlet of electrolyte solution (anolyte or catholyte) outside the electrochemical cell. The design of the cell is symmetrical. The positive and negative compartments have the same layout.

For the two compartments (positive and negative), the tube (11a; 13a) passing through its thickness the ring placed flat against a membrane (3) is therefore positioned so as to be at the bottom of the unit cell.

For the two compartments (positive and negative), since the tube (12a; 14a) passes through its thickness, the ring (12; 14) placed flat against the external supporting plate of the device is positioned so as to be at the top of the unit cell. In this way, the electrolyte solution fills the compartment and comes out by the top of the unit cell to be discharged into the receiving tank;
an ion-permeable membrane (3); Nafion® disk with a diameter of 9 cm enabling the passage of hydroxyl ions (OH—) only;
two tanks (4) (5) with a capacity of 1 liter;
two peristaltic pumps (6) (7), made by Gilson®;
an electrolyte solution common to the anolyte and the catholyte, namely an aqueous solution of sodium hydroxide (NaOH) at one mole per liter;
a reducing agent, namely hydrazin 0.2 mol/L in the anolyte;
an oxidizing agent, namely potassium ferricyanide at 0.8 mol/L in the catholyte.

More specifically, the unit cell has a positive compartment (10) provided with the anode (2) and a negative compartment (20) provided with the cathode (1). These compartments are separated by membranes (3) permeable to hydroxyl ions.

The tank (5) of the cathode is provided with a first conduit (5a) for conveying catholyte into said positive compartment, this first conduit (5a) being connected to the tube (11a) and a second conduit (5b) for discharging catholyte from said positive compartment, this second conduit (5b) being connected to the tube (12a). The first pump (7) enables the circulation of the catholyte in a circuit comprising the tank (5) of catholyte, the first conduit for conveying catholyte into the positive compartment, the positive compartment and the second conduit for discharging catholyte.

The tank (4) of anolyte is provided with a first conduit (4a) for conveying said anolyte into said negative compartment, this first conduit (4a) being connected to the tube (13a), and a second conduit (4b) for discharging said anolyte from said negative compartment, this second conduit (4b) being connected to the tube (14a). The second pump (6) enables the circulation of anolyte in a compartment comprising the tank (4) of anolyte, the first conduit for conveying anolyte into the negative compartment, the negative compartment and the second conduit for discharging anolyte.

The membrane (3) is crossed solely by the supporting electrolyte. As a consequence, each electrolyte solution (anolyte or catholyte) is forced to pass through the corresponding porous electrode (anode or cathode).

According to the invention, said positive compartment (10) comprises a positive downstream compartment (10a) and a positive upstream compartment (10b) separated by said anode (2), the first conduit for conveying catholyte being connected to said positive upstream compartment and said second conduit for discharging catholyte being connected to said positive downstream compartment; and said negative compartment (20) comprises a negative downstream compartment (20a) and a negative upstream compartment (20b) separated by said cathode (1), the first conduit for conveying anolyte being connected to said negative upstream compartment and said second conduit for discharging anolyte being connected to said negative downstream compartment; said catholytes and anolytes travelling in transit by percolation respectively through said anode and said cathode, in orthogonal flows.

The flow rate of the two solutions was set for experimental purposes at 2 mL/min.

The electromotive force (e.m.f.) at the terminals of the electrodes and the intensity of the circuit were measured by means of a voltmeter and ammeter, with the device at rest and in operation. The results according to table 1 here below were observed:

TABLE 1

| | | Intensity of |
|---|---|---|
| | e.m.f. | the current |
| Performance | (mV) = U | (mA) = I |
| Rest mode | 900 | 0 |
| Operating | 350 | 600 |

The operating power P=U.I=210 mW is deduced therefrom.

For 10 liters of hydrazine solution (0.2 mol/L) or potassium ferricyanide (0.8 mol/L), the quantity of charge corresponding to the number of electrolytes capable of being exchanged is 96500C×8=77200 Coulomb. Table 2 here below summarizes the performance in terms of duration of operation of the fuel cell for a flow rate of 2 mL/min and a current intensity of 0.5 A (500 mA) in continuous operation. The test is performed for an arbitrarily chosen value of intensity but makes it possible to guarantee constant intensity under defined conditions of operation. Indeed, if for example the flow rate has just changed slightly, then the intensity will decrease slightly. In order to prevent this type of artifact during the operation of the fuel cell and ensure constant intensity, the test can be performed at 80-90% of the capacity of the fuel cell. Other values of intensity are also appropriate, for example 550 or 450 mA. The intensity of the current desired can be set by the series connection, for example, of an adapted resistor. This procedure is a classic test procedure for fuel cells.

TABLE 2

| | Duration of operation (hour) | | |
|---|---|---|---|
| | 8.5 | 107 | 214 |
| Rate of | 2 | 25 | 50 |
| discharge (%) | | | |

The rate of discharge corresponds to the computation of the percentage of the quantity of electricity used, computed on the basis of the theoretical load which is 772000 Coulomb and reflects the impoverishment of the anolyte in hydrazine and of the catholyte in ferricyanide.

The duration of operation of 8.5 hours corresponds to the passage of 10 liters of electrolyte in the cell. Beyond this time and given the low impoverishment of hydrazine in the anolyte and of ferricyanide in the catholyte, these two solutions are sent back to their initial tanks respectively (4) and (5) and the flow system is looped.

In the oxidation/reduction reactions brought into play in the anode and the cathode, the hydrazine exchanges four electrons while the ferricyanide exchanges only one electron. This explains why the ferricyanide concentration is four times higher than the hydrazine concentration. The two anolyte and catholyte solutions are balanced in concentration and both of them get proportionally and stoichiometrically impoverished.

It is observed that, after 214 hours of operation, only 50% of the energy capacity of the reservoir has been consumed while maintaining a continuous production of 0.5 Amperes for 214 hours. This therefore confirms the fact that the device according to the invention has a high energy capacity enabling its use to be envisaged in large-scale stationary applications i.e. in residences and other buildings as a means of heating, air conditioning or supplying current. When parallel-connected, several unit cells of the device according to the invention can conduct the desired current intensity. When series-connected they can conduct the desired e.m.f.

For a 10000-liter tanks, the quantity of electricity corresponds to 772×10⁶ Coulomb. This great quantity of electricity can be distributed in the form of high current intensity or in the form of potential difference (p.d.) and this can be done for several days. The system then can easily be integrated into a local method for the production of energy (photovoltaic, wind energy, etc) to store energy. In particular, it can play an energy-shedding role in compensating for the non-production of energy by wind and photovoltaic systems (when there is no wind and light).

For 40-litre to 50-litre tanks, the device can be used as an electricity generator for medium-sized electrical vehicles, with the current consumption varying from 60 to 80 A.

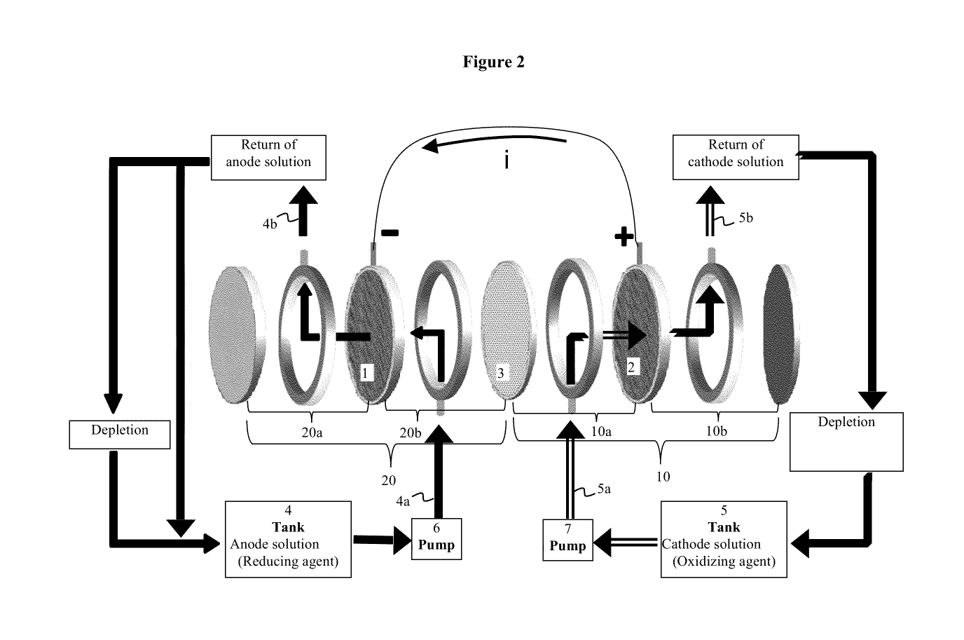

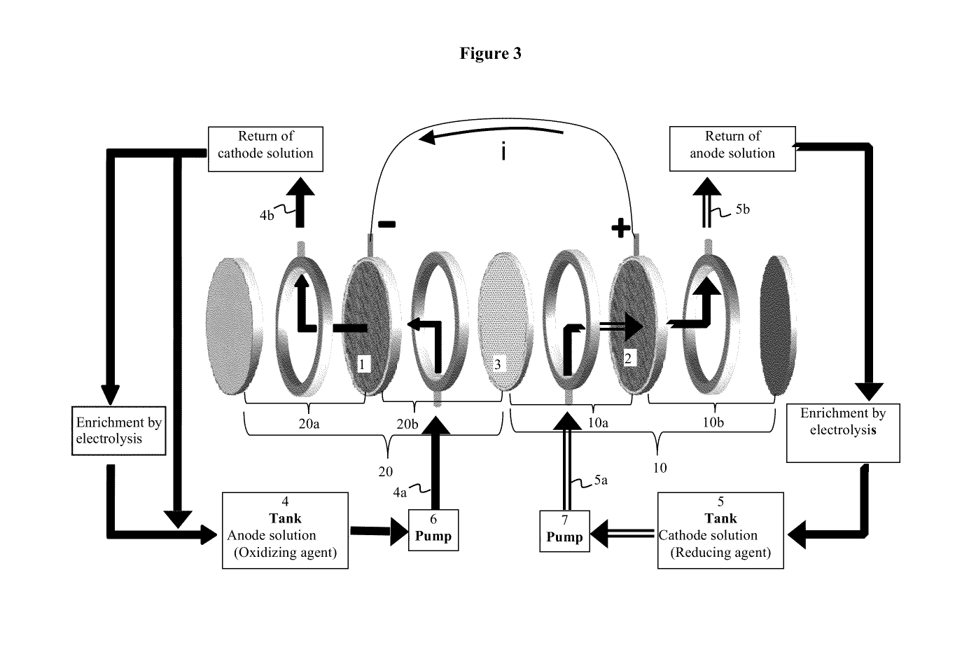

The second embodiment made is described with reference to FIG. 2 (“discharge” mode) and FIG. 3 (“charge” mode). This second embodiment can be distinguished from the first embodiment described with reference to FIG. 1 in that:
the membrane (3) is juxtaposed with the electrodes (1, 2) without demarcating any compartment between the membrane and the electrodes;
the entry of anolyte by the pipe (4a) is done at the supporting plate (15) while the entry of catholyte by the pipe (5a) is done at the supporting plate (16);
the exit of anolyte by the pipe (4b) is done at a holding ring (1a) surrounding the porous electrode (1) provided with a tube (1b) passing through it and connected to the pipe (4b) while the exit of catholyte is done at a supporting ring (2a) surrounding the porous electrode (2) provided with a tube (2b) passing through it and connected to the pipe (5b);
the rings (12b, 14b) demarcating the downstream compartments (20a, 10b) are not provided with tubes passing through them;
the current is received by conductive rings (17, 18).

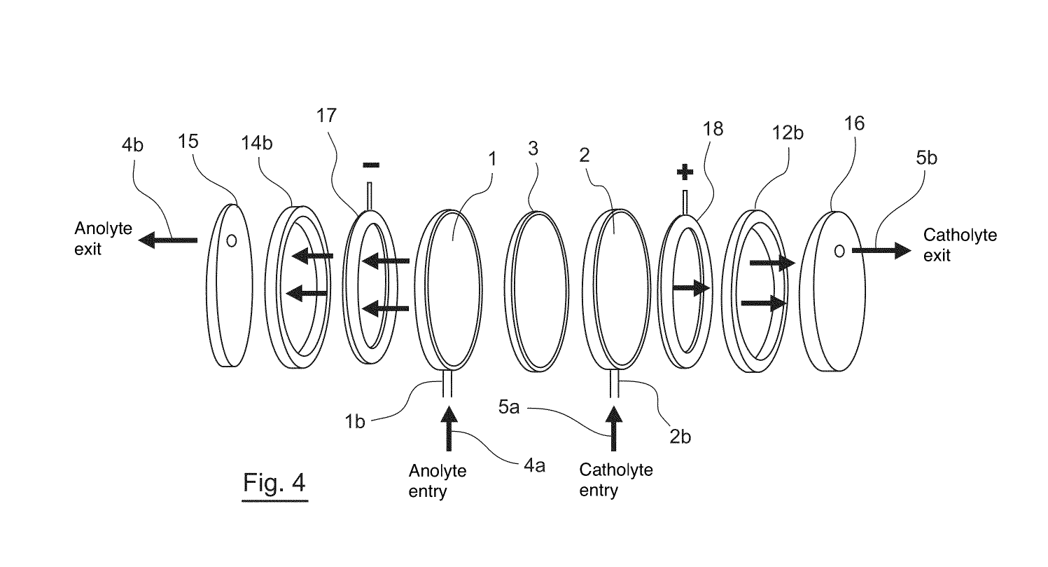

The third embodiment made is described with reference to FIG. 4 in which the tanks of anode and cathode solutions as well as the loops for regenerating and enriching these solutions are also not shown. This third embodiment can be distinguished from the first embodiment described with reference to FIG. 2 in that:
the entry of anolyte by the pipe (4a) is done by the tube (1b), the exit of anolyte by the pipe (4b) being done by the holding ring (15);
the entry of catholyte by the pipe (5a) is done by the tube (2b), the exit of catholyte by the pipe (5b) being done by the holding ring (16).

This third embodiment therefore differs from the second embodiment by the sense of circulation of the electrolytic solutions.

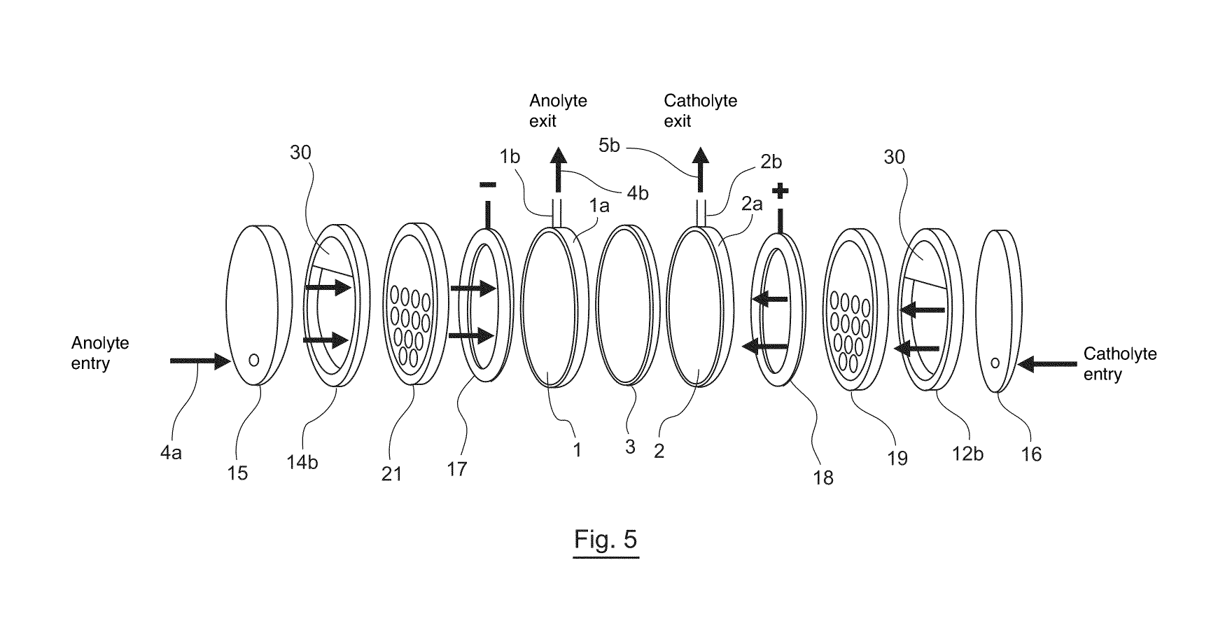

The fourth embodiment made is described with reference to FIG. 5 in which the tanks of anode and cathode solutions as well as the loops for regenerating and enriching these solutions are also not shown. This third embodiment can be distinguished from the first embodiment described in FIG. 2 in that:
a distribution plate (19) is provided between the ring (12b) and the electrode (2) and another distribution plate (21) is provided between the ring (14b) and the electrode (1). These distribution plates are drilled with holes on two-thirds of their height, the upper third therefore constituting an obstacle to the passage of electrolyte solutions;
a solid plate (30) made of Teflon® cooperates with each of the rings (14b and 12b) so as to fill the upper third of the compartment demarcated by each ring. This Teflon® plate is an obstacle to the passage of the solution. Thus, each solution impregnates only the lower two-thirds of each electrode. Under the stresses provided by the distribution plate (19, 21) and the membrane (3), the solutions circulate tangentially along the upper third of the electrodes and emerge by the holding parts (1a, 2a) by the tubes (1b, 2b). Each distribution plate makes it possible to maintain the associated electrode against the membrane under slight pressure. The assembling of the two electrodes and the membrane between the two distribution parts is optimized in its thickness and in its holding and also ensures maximum ion conductivity in minimizing the ohmic drop. It can be noted that the ohm drop (Rₒₕₘ) is the resistance due to the solution. The greater the distance between the electrodes, the greater is the ohmic drop. This phenomenon leads to a drop in the electromotive force of the unit cell by a value E=i×Rₒₕₘ. This drop is proportional to the ohmic drop.

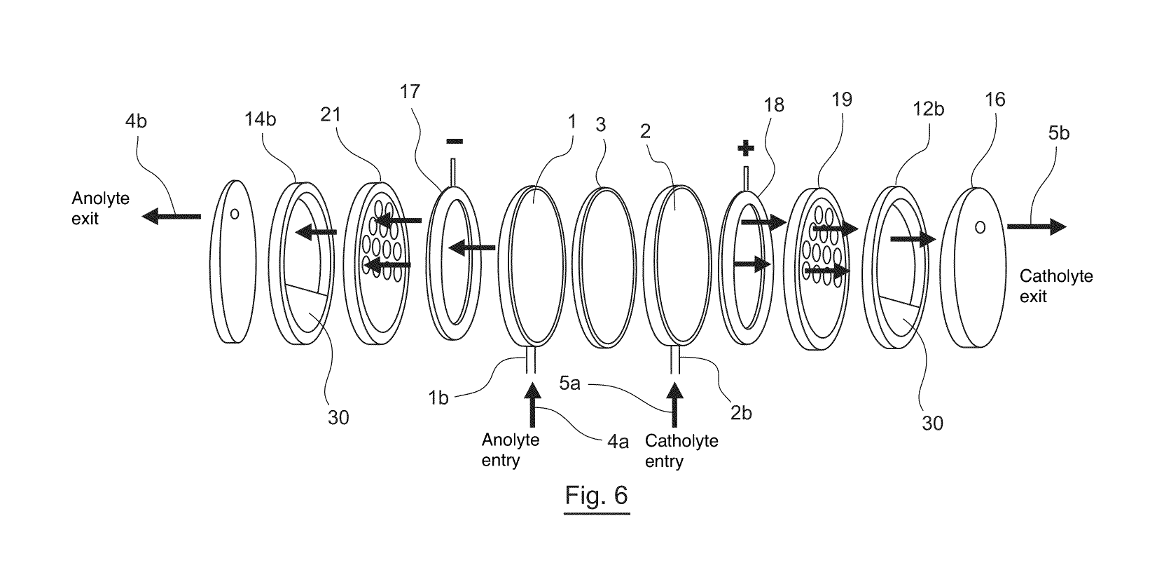

The fifth embodiment made is described with reference to FIG. 6 in which the tanks of anode and cathode solutions as well as the loops for the regeneration and enrichment of these solutions are not also represented. This third embodiment can be distinguished from the first embodiment described with reference to FIG. 4 in that:
the distribution plates are drilled with holes on two-thirds of their height, the lower third then constituting an obstacle to the passage of the electrolyte solution;
a Teflon® plate cooperates with each of the rings (14b and 12b) so as to fill the lower third of the compartment demarcated by each ring;
the entry of anolyte by the pipe (4a) is done by the tube (1b), the exit of anolyte by the pipe (4b) is done by the holding ring (15);
the entry of catholyte by the pipe (5a) is done by the tube (2b), the exit of catholyte by the pipe (5b) is done by the holding ring (16).

This fifth embodiment therefore differs from the fourth embodiment in the sense of circulation of the electrolyte solutions.

The first embodiment as well as the other embodiments were also tested in fuel cell mode implementing the following compounds:
as a reducing agent: ascorbic acid 1 mol·L⁻¹
as an oxidizing agent: potassium ferricyanide 1 mol·L⁻¹.

The following table 3 indicates the current densities then obtained with these different embodiments:

TABLE 3

| Embodiment | Average current |
|---|---|
| No | density (mA/cm²) |
| 1 | 27 |
| 2 | 38 |
| 3 | 44 |
| 4 | 55 |
| 5 | 55 |

The comparison of the results obtained with the embodiments 1 and 2 for which the membrane is juxtaposed or not juxtaposed with the electrode emphasizes the value of juxtaposing the electrode with the membrane.

The comparison of the results obtained with the embodiments 2 and 3, for which only the sense of circulation of the solution is inversed, shows the value of implementing a sense of flow of this solution going from the membrane to the working electrode.

The comparison of the results obtained with the embodiments 2 and 4 on the one hand and the comparison of the results obtained with the embodiments 3 and 5 on the other hand in which the solution is guided by the Teflon® plates and the distribution plates shows the value of implementing such a guidance through such elements.

Finally, the second embodiment was also tested in battery mode in replacing the hydrazine and the potassium ferricyanide, which are irreversible reducing and oxidizing agents, by the following compounds:
as the reversible reducing agent: 1,2,4,5-tetraol benzene (0.5 mol·L⁻¹, equivalent to 1 mole of exchanged electrons);
as a reversible oxidizing agent: potassium ferricyanide (1 mol·L⁻¹, equivalent to 1 mole of exchanged electrons).

The working in discharge mode is represented in FIG. 2, while the working in charged mode is represented in FIG. 3.

In the charged mode of the battery, 1,2,4,5-tetraol benzene is obtained by electrochemical reduction directly in contact with electrodes of 2,5-Dihydroxy-[1,4]benzoquinone, which is a product that is commercially available.

1. Fuel cell device with circulating electrolytes comprising:
at least one unit cell having a positive compartment provided with an anode and a negative compartment provided with a cathode, said compartments being separated by an ion-permeable membrane;
at least one tank of a catholyte, provided with a first conduit for conveying catholyte into said positive compartment and a second conduit for discharging catholyte from said positive compartment;
at least one first pump enabling the circulation of the catholyte in a circuit comprising the tank of catholyte, the first conduit for conveying catholyte into the positive compartment, the positive compartment and the second conduit for discharging the catholyte;
at least one tank of anolyte, provided with a first conduit for conveying said anolyte into said negative compartment and one second conduit for discharging said anolyte from said negative compartment;
at least one second pump enabling the circulation of anolyte in a circuit comprising the anolyte tank, the first conduit for conveying anolyte into the negative compartment, the negative compartment and the second conduit for discharging anolyte;
said cathode and said anode having a porous three-dimensional structure;
characterized in that said positive compartment comprises a positive downstream compartment and a positive upstream compartment separated by said anode, the first conduit for conveying catholyte being connected to said positive upstream compartment and the second conduit for discharging catholyte being connected to said positive upstream compartment,
and in that said negative compartment comprises a negative downstream compartment and a negative upstream compartment separated by said cathode, the first conduit for conveying anolyte being connected to said negative upstream compartment and the second conduit for discharging anolyte being connected to said negative downstream compartment,
said catholyte and anolyte being capable of travelling in transit by percolation respectively through said anode and said cathode;
the solutions of catholyte and anolyte passing through said anode and said cathode in a flow orthogonal to the longitudinal axis of said anode and said cathode.

2. Device according to claim 1 characterized in that said cathode and/or said anode are made out of a material chosen from the group constituted by foams, felts, fabrics and overlaying of fabrics.

3. Device according to claim 2 characterized in that said cathode and/or said anode are made out of a graphite-fiber felt

4. Device according to claim 3 characterized in that said cathode and/or said anode are made out of a felt made with metalized graphite fibers.

5. Device according to claim 3 characterized in that said cathode and/or said anode are coated with a polymer film.

6. Device according to claim 1, characterized in that at least one catalyst is fixed by covalent bonding to the surface of said cathode and/or said anode.

7. Device according to claim 5 characterized in that at least one catalyst is fixed covalently to said polymer film.

8. Device according to claim 1, characterized in that said membrane is juxtaposed with the cathode and the anode.

9. Device according to claim 1, characterized in that the circulation of catholyte is implemented in the sense going from the membrane to the anode and the circulation of anolyte is implemented in the sense going from the membrane to the cathode respectively.

10. Device according to claim 1, characterized in that it comprises a plate for distributing the flow of anolyte and a plate for distributing the flow of catholyte.

11. Device according to claim 1, characterized in that said catholyte and said anolyte comprise irreversible reducing and oxidizing agents.

12. Device according to claim 1, characterized in that said catholyte and said anolyte comprise reversible reducing and oxidizing agents, the device being thus capable of working in discharge mode and in charging mode by apposition of an electrical current from a source external to the terminals of the anode and the cathode.

13. Device according to claim 12 characterized in that said catholyte comprises hydrazine, or ascorbic acid or hydroquinones and said anolyte comprises potassium ferricyanide.

14. Device according to claim 13 characterized in that said catholyte and said anolyte are cyclams complexated with a transition metal.
